(19) United States
(12) Patent Application Publication
(10) Pub. No.: US 2005/0019468 A1
(43) Pub. Date: Jan. 27, 2005

(54) Pasteurization of deli-salads

(76) Inventor: Walter Johannes Freybe, Abbotsford (CA)

Correspondence Address: Walter J. Freybe, # 93 - 31406 Upper Maclure Road, Abbotsford, BC, V2T 5L8, CA

(21) Appl. No.: 10/724,533

(22) Filed: Nov. 28, 2003

(30) Foreign Application Priority Data
Jul. 22, 2003 (CA) 2,434,464

(51) Int. Cl. A23L 3/16

(52) U.S. Cl. 426/521

(57) ABSTRACT

Deli-salads are normally produced with preservatives to achieve the shelf life demanded by the retail food industry. This invention relates to the process of manufacturing Deli Salad products without the use of preservatives other than salt, sugar, or other sweeteners and food acidulates. Salads prepared, processed and pasteurized in this manner, will have a minimum refrigerated shelflife of 60 days without impairing the taste of the salad or the crispness of the vegetables. Salad dressings are mixed with vegetables such as potatoes or any other agriculture grown product or manufacturer thereof. This mixture is then packed into plastic bags. The bags are heat sealed and pasteurized. After removal from the heated environment, the bags are rapidly cooled.

### TECHNICAL FIELD

This invention relates to a process of manufacturing deli-salad products which are prepared with no preservatives other than salt, sugar or sweeteners and food acidulates.

This invention relates in particular to a process where the salad is packed in plastic bags, pasteurized and rapidly cooled to avoid a measurable bacteria count

### BACKGROUND

Presently, most deli-salads for bulk display or retail packaging are usually packed into plastic containers ranging in size from 215 g to 15 kg containers. A long shelflife is achieved by adding preservatives such as potassium sorbate, sodium benzoate or other chemicals.

This invention will allow the production and packaging of these deli-salads without such preservatives and allow these salads to be kept refrigerated for a period of at least 60 days without impairing the quality.

### SUMMERY OF THE INVENTION

The process of preparing deli-salads according to the invention resulting in a long shelflife after pasteurization and rapid cooling comprises of the following:

Vegetables such as potatoes or any other agriculture grown food product or manufacture thereof are prepared in a normal manner according to desired cut of vegetables or pre cooking of other ingredients such as pasta. This base is then mixed in a normal manner with varying proportions of regular prepared salad dressings which may contain water, oil, egg products, seasonings, spices, herbs, sugar, salt, food acidulates, vegetable products, starches, flour, vegetable gums, and other non preservative food ingredients as may be needed to create the desired flavour profile and stability of the emulsion. In order to achieve the same flavour and mouthfeel it may be necessary to vary the concistency of the dressing used in pasteurized salads from the concistency of dressings normally used in regular cold packed salads. It may also be necessary to vary the percentage of dressing to solids in pasteurized salads from the percentage of dressings to solids normally used in regular cold packed salads. Per instance the salads shown in table (1) were adjusted in the following manner:

Four bean salad:

| | |
|---|---|
| Regular cold packed salads: | |
| 75.3% solids | 24.7% dressing |
| Pasteurized salad: | |
| 73.4% solids | 26.6% dressing (concistency of the |
| | dressing was the same in both cases.) |

Thai Noodle salad:

| | |
|---|---|
| Regular cold packed salad: | |
| 71.1% solids | 28.9% dressing |
| Pasteurized salad: | |
| 72.4% solids | 27.6% dressing |
| Dressing in the pasteurized | |
| salad was changed as follows: | |
| Increase starch by | .8% |
| Increase soya sauce by | 8.62% |
| Decrease water by | 6.29% |
| Decrease vinegar by | 3.13% |

Potato & Egg salad:

| | |
|---|---|
| Regular cold packed salad: | |
| 79.4% solids | 20.6% dressing |
| Pasteurized salad: | |
| 65.2% solids | 34.8% dressing |
| Dressing in the pasteurized | |
| salad was changed as follows: | |
| Xantham gum increased by | .22% |
| Liquid egg reduced by | 6.29% |
| Enzyme modified egg | |
| product added | 4.00% |
| Oil reduced by | 6.10% |
| Vinegar reduced by | 3.40% |

Red potato salad

| | |
|---|---|
| Regular cold packed salad: | |
| 73% solids | 27% dressing |
| Pasteurized salad: | |
| 66% solids | 34% dressing |
| Dressing in the pasteurized | |
| salad was changed as follows: | |
| Xantham gum increased by | 2.95% |
| Liquid egg reduced by | 5.00% |
| Enzyme modified egg | |
| product added | 3.90% |
| Oil increased by | 2.10% |
| Vinegar reduced by | 0.59% |
| Lactic acid increased by | 1.30% |

The salads were packed into sealable, heat resistant plastic bags. The bags each holding 2 kg had the following dimension.:

44 cm long, 20 cm wide, and 3.8 cm deep. At a temperature of 90° C. the bags were pasteurized for 60 minutes. The core temperature was 72° C. for 16 minutes. Immediately after removal from the hot environment the bags were cooled for 60 minutes at which time the core temperature was 10° C. The bags were then refrigerated for 60 days at a temperature<4° C.

The effect of the pasteurization and cooling process in this manner achieved the results shown in the following certificate of analysis:

TABLE 1

| | | thai | | |
|---|---|---|---|---|
| | 4 bean | noodle | potato | red potato |
| | salad | Salad | &egg sal. | Salad |
| Standart plate count | <10 | <10 | <10 | <10 |
| Total coli forms | <2 | <2 | <2 | <2 |
| Fecal coliforms | <2 | <2 | <2 | <2 |
| Escherichia coli | — | — | — | all negative |
| Salmonella species | — | — | — | all negative |
| Staphylococcus aureus | — | — | — | all negative |
| Pseudomonas aeruginosa | — | — | — | all negative |
| Bacillus cereus | — | — | — | all negative |
| Clostidium perfringens | — | — | — | all negative |
| Listeria monocytogenes | — | — | — | all negative |
| Lactobacillus species | — | — | — | all negative |
| Yeast | <10 | <10 | <10 | <10 |
| Mold | <10 | <10 | <10 | <10 |

The size and weight of the 2 kg bags, the pasteurizing temperature and the length of the pasteurization process were chosen as an example. In this example it was demonstrated that by pasteurizing these bags at 90° C., holding the core temperature for 16 minutes at 72° C. and cooling the product to <10° C. within 60 minutes all measurable bacteria were destroyed. The process of using plastic bags in the manner described can be used for any size bag and at temperature as high as 99° c and as low as 65° C. In every case the degree of the critical core temperature and the length of time the particular size of bag must be held at this core temperature, needs to be established.

### CROSS REFERENCES CITED

### Patent Documents

WO 91/11108 Juillard at al. published Aug. 8, 1991

This patent corporation treaty application discloses a process whereby vegetables are vacuum sealed and a prescribed proportion of lemon juice is added to the bag. The vegetables and the lemon juice in the bag are heated to a temperature between 80° to 98° C. The application claims that bags containing vegetables which have been treated in this manner can be kept for periods up to a year at 4°-6° C. The length of the pasteurization process is between 30 and 120 minutes. At one location, it is stated that the concentration of the lemon juice is between 0.1 and 0.5%.

Our process does not require the addition of lemon juice even though it might be part of a particular desired flavour profile. Our process does not require a vacuum pack.
EP 0 553 603 A1, Cancarini, published Aug. 8, 1993

This patent discloses a process for vacuum packing fruit in sealed bags. The fruit in the bags is pasteurized at about 90° c for about 15 to 40 minutes. The treated bags are then cooled in cold water to about 4°-8° C. The patent at one location states that the vacuum is about 90%. It is also stated that a minimum pasteurization process temperature can be about 80° C. It is stated that fruit, mainly pineapple, treated in this manner lasts for about 90 days under normal refrigeration.

Our process does not require a vacuum. It is also noted that this patent is for fruit and not salads.
U.S. Pat. No. 5,192,565, Buhler et al., Mar. 9, 1993

This patent discloses a process whereby vegetables and fruits are heat treated for 1 to 15 minutes at a temperature of between 800 to 95° C. to blanch the fruits and vegetables. The blanched fruits and vegetables are then cooled. Subsequently, the blanched and cooled vegetables are fermented with lactic bacteria and water to reach a p.h. of about 3.1 to 4.4. The fermented vegetables are then pasteurized at about 80° C. to about 110° C. for 2 to 30 minutes.

Our process requires no fermentation with lactic bacteria.
U.S. Pat. No. 5,114,733, Quinet, May 19, 1992

This patent discloses a process whereby an oil emulsion is prepared from oil, emulsifier, stabilizer, thickener and water under vacuum. Egg yolk is then added and the mixture is further emulsified under vacuum. A salad is then prepared combining the oil emulsion and salad ingredients. The mixture is packed into an airtight container and is then pasteurized in an over pressure autoclave. The product is then cooled and overpressure is applied during this process.

Our process does not require that the dressings or oil emulsions have to be made under vacuum and does not require that the pasteurizing and cooling process be performed in an overpressure environment. Temperatures are similar to the standard requirement of any pasteurization process.
U.S. Pat. No. 4,832,063, Demeulemeester et al., May 23, 1989

This patent discloses vacuum packaging vegetables which are pasteurized for about 5 to 15 minutes at 85°-95° C. The vacuum packed vegetables are then subjected to a bacterial treatment for 24-27 hours. at a temperature of about 25°-30° C. After bacterial treatment, a second pasteurization step is conducted for 20 to 40 minutes at about 850 to 93° C. The vacuum packed vegetables are then refrigerated.

Our process does not require bacterial treatment.
EP 0 401 939, Quinet, Dec. 12, 1990

This patent is similar to U.S. Pat. No. 5,114,733 (shown before)
French patent No., 2,784,864, Albino et al., published Apr. 28, 2000

This patent states that storage time of vegetables are increased by pre-cooking and pasteurization. The vegetables are pre-cooked and chilled. The cooked vegetables are then packed in a sauce in a container. The container is then pasteurized under vacuum or under nitrogen blanket. Pasteurization seems to be conducted at about 90 C to 110 C for 10 to 25 minutes.

Our process does not require vacuum or nitrogen blanket.
U.S. Pat. No. 4,505,937, Demeulemeester et al., Mar. 19, 1985

This patent is similar to the earlier Demeulemeester et al., patent discussed above. This patent discloses a process whereby root and tuber vegetables (notably potatoes) are lightly sterilized at 75 to 85 C for about 5 to 15 minutes. The lightly sterilized root and tuber vegetables are then packaged in pouches which are cooled to about 40 C by spraying with Water. The root and tuber vegetables are incubated in the pouches at about 25 C for 24 hours. A second pasteurization step is conducted at a temperature of about 85 C for about 30-40 minutes. Finally, the root and tuber vegetables in the pouches are refrigerated at 5 C to 15 C for about 3 to 12 hours.

Our process does not require a pre-sterilization process or incubation period.
U.S. Pat. No. 3,966,980, McGuckian, Jun. 29, 1976

This patent discloses a process of cooking foods in vacuum packages. Foods such as meat and vegetables, are placed in vacuum pouches and immersed in water at 1400 to 212° F. until the food is cooked. The packages containing cooked foods are then immersed in chilled water of a temperature of about 320 to 34° F.

Our process does not cook the salad ingredients in the bags. In effect our process avoids cooking to retain crispness of the vegetables.
U.S. Pat. No. 3,892,058, Komatsu et al., Jul. 1, 1975

In this patent, packages filled with food are heated to about 130° C. to about 160° C. for a short period of time, for example 0.5 to 15 minutes in order to sterilize the food contained in the packages.

Our process could not use these high temperatures as they would impair the quality and emulsion of many of the dressings used in our process. The short heating time in this process would not achieve the necessary core temperatures needed in our process.

### DISCLOSURE

Disclosure of this product has been made on Dec. 3, 2002, when the first product was sold to a customer.

1. I claim a simplified process of preserving deli-salads without preservatives for a minimum of 60 days consisting of using the following processing method:
The basic ingredients are selected from agriculture products in a form suitable for the desired finished product. A dressing is either mixed or emulsified, using standard dressing ingredients without the use of preservatives.
The basic ingredients and the dressing are mixed together. They are then packed into a plastic bag suitable for the weight of the product to be packaged. The bag is then pasteurized and after the pasteurization process is completed the bags are rapidly cooled. The core temperature required to destroy measurable numbers of bacteria must be determined and will depend on the size of bag and the temperature at which it is pasteurized
